(19) United States
(12) Patent Application Publication
(10) Pub. No.: US 2016/0257360 A1
(43) Pub. Date: Sep. 8, 2016

(54) Modular Vehicle Architecture

(71) Applicant: THALES AUSTRALIA LIMITED, New South Wales (AU)

(72) Inventors: CRAIG LACHLAN MACKENZIE, Maiden Gully (AU); GREG HARRIS, White-Hills (AU)

(21) Appl. No.: 15/032,811

(22) PCT Filed: Oct. 31, 2014
(86) PCT No.: PCT/AU2014/001034

§ 371 Date: Apr. 28, 2016

(30) Foreign Application Priority Data
Oct. 31, 2013 (AU) 2013101433
Oct. 31, 2013 (AU) 2013904207

(51) Int. Cl. B62D 63/02; B62D 25/08; B62D 21/11; F41H 7/04

(52) U.S. Cl. CPC B62D 63/025; F41H 7/048; B62D 25/082; B62D 21/11; B60Y 2200/22; B60Y 2200/24; B60Y 2200/41; B60Y 2200/116

(57) ABSTRACT

The present invention relates to the field of mechanical engineering, in particular, vehicles. In one form, the invention relates to military or defence industry protected (armoured) vehicles with a modular vehicle architecture comprising: a capsule adapted for accommodating at least one occupant; at least one sub-frame detachably operatively connected to the capsule; wherein at least the sub-frame construction comprises members of tubular structure having a cross section corresponding to a conic section.

### RELATED APPLICATIONS

This application claims priority to Australian Provisional Patent Application No. 2013904207 in the name of Thales Australia Limited, which was filed on 31 Oct. 2013, entitled “Modular Vehicle Architecture” and, to Australian Innovation Patent Application No. 2013101433 in the name of Thales Australia Limited, which was filed on 31 Oct. 2013, entitled “Modular Vehicle Architecture” and the specifications thereof are incorporated herein by reference in their entirety and for all purposes.

### FIELD OF INVENTION

The present invention relates to the field of mechanical engineering and, in particular it relates to vehicles. In one form, the invention relates to military or defence industry protected (armoured) vehicles. The invention may also be applicable generally to land vehicles, for example, vehicles used in mining, fire fighting, police, emergency services, automotive industry and agriculture. It will be convenient to hereinafter describe the invention in relation to a military protected vehicle; however it should be appreciated that the present invention is not limited to that use, only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Modular vehicle assemblies are generally known and some examples are as follows.

A combat tactical modular vehicle structure is disclosed in WO 2010/044944 (Alcoa Inc.) and its related patent family members which includes a center frame module comprising a front bulkhead, a cab portion, and a rear bulkhead where the center frame module includes an integrated armor so that the integrated armor is a part of center frame module or the center frame module has at least one piece of armor attached to the center frame module, a front frame module comprising an engine subframe where the front frame module is connected to the front bulkhead by a plurality of mechanical coupling devices, and a rear frame module comprising a gearbox subframe where the rear frame module is connected to the rear bulkhead by the plurality of mechanical coupling devices for selectively connecting and disconnecting the front frame module to the front bulkhead without substantially affecting the connection and the rear frame module to the rear bulkhead without substantially affecting the connection.

The design of WO 2010/044944 noted above is generally referred to as a box section sub-frame design. The vehicle structure of WO 2010/044944, along with other example architectures of a similar box section design, can be relatively heavy with the frame itself occupying a lot of space, prone to corrosion and moisture traps where moisture pools or comes to rest within and upon the chassis structure and may not be easy to maintain as maintenance access through the sub-frame is difficult. With respect to WO 2010/044944 by way of example, there is a gearbox for the vehicle located in the rear sub-frame which reduces payload capacity. Generally speaking, having engine and drive components situated in a rear sub-frame as such may reduce payload capacity. In this respect, whilst some payload may be able to be placed at the front of the vehicle but cannot be substantial or of any significant height as visibility would be compromised as a result.

Other example modular designs for vehicles are found in U.S. Pat. No. 4,869,539 (Cassese) where a vehicle support structure comprises a central frame to define the passenger compartment of the motor vehicle, a front frame connected by first resilient connection means to the front part of the central frame and provided with first attachment means for the front suspension, a rear frame connected by means of second resilient connection means to the rear part of the central frame and provided with second attachment means for the rear suspension; the said rear frame substantially supports the motor vehicle engine and some of the transmission members whilst the front frame supports the other transmission members.

U.S. Pat. No. 4,881,756 (Kumasaka et al) discloses a vehicle frame, which consists of three longitudinally separate frame sections, i.e., a front frame section, center frame section and a rear frame section. The front, center and rear frame sections are manufactured and assembled in respective independent fabrication lines and painted and equipped with chassis sub-assemblies independently, whereby to constitute a front frame module, center frame module and a rear frame module, respectively. The frame modules are finally bolted together to constitute a complete chassis.

U.S. Pat. No. 7,228,927 (Hass et al) discloses a vehicle with protection against the effects of an exploding land mine, in which a military wheeled vehicle is provided with wheel axels and drives built into front and/or rear building blocks. The vehicle is divided into multiple building blocks, and a three block construction is desirable (i.e., a front building block, a rear building block, and a main building block). A residual mobility of a remaining portion of the vehicle is preserved, even though one of the front building block or the rear building block is separated from the main building block due to the explosive shock wave generated by driving over and detonating a land mine, because each of the front building block and the rear building block has a drive for rotating the wheel axel connected to the block.

U.S. Pat. No. 7,594,561 (Hass et al) also discloses a mine protection vehicle system wherein the vehicle has a three-sectioned vehicle construction that includes a front building block, a main building block and rear building block. The building blocks are separable from one another. The main building block may be designed to be slanted toward the bottom and double walled. A cabin, serving to provide a crew space, is hung up on a support structure of the main building block. Wheel axles and drives are built into the front and/or rear building block; however, no wheel axle is disposed below the main building block.

WO 2012/116694 (Krauss-Maeffei Wegmann GmbH & Co. KG) is not necessarily a box section modular design but discloses a military vehicle, comprising a front section and a rear section and a safety cell arranged between the front section and the rear section for receiving the vehicle crew, the front section and the rear section being connected to each other in the region below the safety cell by means of a protective element which protects the safety cell from the impact of blasts.

Other vehicle chassis designs may include non-modular full chassis in one piece arrangements and may be generally heavier as the whole vehicle is protected, not just an isolated capsule per se. Another example is the so-called truck chassis with a C section and this design is considered relatively weak with torsion applied to it. Further, it can't easily be replaced if damaged.

In summary, box section sub-frame designs are generally heavier and more prone to moisture and corrosion and are less easy to maintain. Non modular vehicles (full chassis in one piece) are susceptible to be heavier as the whole vehicle is protected not an isolated capsule. Also it is noted that a truck chassis with a C section is a design that is weak with torsion and can't be easily replaced if damaged.

With regard to protected vehicles, as described in WO 2010/044944, it is noted that the cab portion of such vehicles is designed for survivability of the crew. Furthermore, modular bulkheads for adjoining to the center portion at the front and rear of the vehicle are designed to defend against ballistic and mine blast threats. In current vehicle designs both front and rear bulkheads are very difficult or impossible to be up-armored from A-kit armor known in the military for lower level threats to B-Kit armor that is commonly installed/bolted on for upper level threats that occur during combat missions. Thus, B-Kit capabilities are commonly built in each vehicle which then has to carry more weight even during non-combat missions. As would be appreciated from this situation, it would be desirable to minimize the weight of a vehicle without affecting its structural integrity or, moreover, for protected vehicles to minimize weight particularly whilst there may be a requirement for the added bulk of retaining a suitable defence against ballistic and other blast threats.

When considering the design and/or architecture of a vehicle frame or chassis it is also generally desirable to avoid adverse effects of diminishing the payload capacity of a vehicle. With protected vehicle designs, for example, blast protection has necessitated drive components like the engine and gearbox to be moved away from underneath the passenger capsule of cab portion(s) of a vehicle. As shown in WO 2010/044944 commonly this has led to separating drive components to be situated both in front and to the rear of the cab, however, this can lead to payload capacity being compromised. Further to this, in accommodating additional drive and vehicle components that were hitherto residing at or within the cab, the front and/or rear portions of the vehicle design under conventional frame design may restrict space for vehicle components.

### SUMMARY OF INVENTION

It is an object of the embodiments described herein to overcome or alleviate at least one of the above noted drawbacks of related art systems or to at least provide a useful alternative to prior or related art systems.

In a first aspect of embodiments described herein there is provided a modular vehicle architecture comprising: a capsule adapted for accommodating at least one occupant; at least one sub-frame detachably operatively connected to the capsule; wherein at least the sub-frame construction comprises members of tubular structure having a cross section corresponding to a conic section.

The sub-frame members preferably have a cross section corresponding to one of a circle or an ellipse. In preferred embodiments the sub-frame members are externally welded and highly visible for maintenance. It is also preferred that the sub-frame members are spaced to avoid moisture traps and liquid pooling within the internal portions of the chassis of the vehicle.

The sub-frame members may be configured to house major functional vehicle components within a sub-frame.

The sub-frame members are preferably configured to allow heat dissipation from major functional vehicle components and auxiliary vehicle components housed within the sub-frame.

In preferred embodiments one or more connections between the capsule and the at least one sub-frame comprises a fastening between a hull plate of the capsule and a sub-frame flange of the sub-frame. The fastening preferably comprises one or a combination of a bolt and a dowel where the dowel is for locating the sub frame assembly during its assembly and the bolt is arranged for tightening upon locating the sub frame assembly such that fatigue loads on the connection are minimised and the dowel is capable of dissipating shearing loads.

In a preferred aspect the present invention provides a vehicle comprising a modular vehicle architecture as disclosed herein wherein the vehicle comprises: a centre module for protecting vehicle occupants comprising the capsule as described above; a rear sub-frame comprising the sub-frame as described above; a front sub-frame comprising the sub-frame as disclosed above, wherein the vehicle is adapted for use as one or more of:

a protected military vehicle;

a civilian passenger vehicle;

a mining vehicle;

a fire fighting vehicle;

a police vehicle;

an emergency services vehicle;

an agricultural vehicle.

In another aspect of embodiments described herein there is provided a modular vehicle architecture comprising: a capsule adapted for accommodating at least one occupant; at least one sub-frame detachably operatively connected to the capsule; wherein a majority of major functional vehicle components are housed within a sub-frame.

Preferably, the major functional vehicle components housed within a sub-frame comprise one or a combination of:

an engine;

a gear box;

a transfer case;

a transmission;

differential;

cooling package;

hydraulics;

electrical charging system;

tiedown provisions;

recovery lug provisions:

suspension connection points.

The sub-frame housing the major functional vehicle components may be connected to the front end of the capsule of the vehicle.

Preferably, the sub frame adapted for connection to the front end of the vehicle capsule is also adapted for connection to different hull configurations of the capsule and one other sub frame comprising one of a plurality of different sub frame configurations is also adapted for connection to said different hull configurations at the rear of the capsule

In preferred embodiments the major functional vehicle components housed within the sub-frame are arranged in a side by side configuration.

The sub-frame construction preferably comprises members of tubular structure having a cross section corresponding to a conic section.

In another preferred aspect the present invention provides a vehicle comprising a modular vehicle architecture as described above wherein the vehicle comprises: a centre module for protecting vehicle occupants comprising the capsule as described above; a front sub-frame comprising the sub-frame as described above; a rear sub-frame detachably operatively connected to the rear of the capsule comprising members of tubular structure having a cross section corresponding to a conic section and adapted for accommodating a payload, wherein the vehicle is adapted for use as one or more of:

a protected military vehicle;

a civilian passenger vehicle;

a mining vehicle;

a fire fighting vehicle;

a police vehicle;

an emergency services vehicle;

an agricultural vehicle.

In yet a further aspect of embodiments described herein there is provided a method of assembling a vehicle comprising one or more of the steps of; providing a centre module comprising a capsule adapted for accommodating at least one occupant; providing a first sub-frame comprising sub-frame members of tubular structure having a cross section corresponding to a conic section; providing a second sub-frame comprising sub-frame members of tubular structure having a cross section corresponding to a conic section; detachably connecting the first sub-frame to the front of the centre module; detachably connecting the second sub-frame to the rear of the centre module.

Preferably, the method of assembling a vehicle further comprises the steps of: installing major functional vehicle components into the vehicle such that a majority of the major functional vehicle components are housed within the first sub-frame. Further the step of installing major functional vehicle components within the first sub-frame preferably comprises arranging the major functional vehicle components in the first sub-frame in a side by side configuration.

The architecture and method of assembly of the present invention in embodiments involves light weight tubular steel construction, an engine-gearbox side by side configuration, improved location for connections such as dowels/guides, vehicle components are attached to the front of the vehicle and rear wall rather than under belly. A separate front and rear sub frame provide modularity. For structural integrity, it is preferred to use a steel system to reduce fatigue effect.

Unlike prior art systems known to the inventor, the present invention has embodiments that eliminate the need for different full chassis configuration for different variants e.g. 6×6 vs. 4×4. Advantageously, corrosion issues may be eliminated as all internal cavities are sealed with the tubular sub-frame design of embodiments. Tubes of the sub-frame are bent around the drive line components which allow easy access for maintenance.

Embodiments involve new use of a tubular steel construction along with a unique flange mounting design. The arrangement of the engine, ISG (Inline starter generator), gearbox, cross drive, transfer case enable an efficient vehicle design that does not compromise payload capacity as prior art systems do.

In still a further aspect of embodiments described herein, there is provided a modular vehicle architecture having: a capsule adapted for accommodating at least one occupant; at least one sub-frame detachably connectable to the capsule and constructed from members of tubular structure having a circular or elliptical cross-sectional profile; wherein one or more connections between the capsule and the at least one sub-frame comprises a fastening between a hull plate of the capsule and a sub-frame flange of the sub-frame, and wherein the fastening comprises a combination of a bolt and a dowel where the dowel is for locating the sub frame assembly during its assembly and the bolt is arranged for tightening upon locating the sub frame assembly such that fatigue loads on the connection are minimised and the dowel is capable of dissipating shearing loads. In this aspect of embodiments the fastening includes a dowel and a plurality of bolts arranged therearound.

In essence, embodiments of the present invention stem from the realization that follows.

Modularity of the vehicle architecture described herein allows different configurations of the vehicle reusing parts and also may allow for having several assembly lines running in parallel and remotely. The use and location of tubes in the tubular construction of the vehicle optimizes strength, weight and maintainability of the vehicle.

Space efficiency is provided in embodiments. In this respect, to enhance mine blast protection, the engine and gearbox were moved away from underneath the capsule. This led to the inventor's design of a side-by-side configuration with cross drive coupling and transfer case axle connections. In preferred embodiments, a single prop shaft under the cabin is the only drive line component under the cabin and it is light weight. Space constraints due to this configuration meant a conventional box section sub-frame may not be appropriate. This drove the development of the preferred tubular design which also provides better torsional rigidity. Particularly preferred in embodiments of the invention is the back-to-front engine arrangement whereby the flywheel end of the engine is facing forwards, and fitted with a cross drive unit that transfers power to the gearbox and transfer case that is fitted, most notably, beside the engine and delivering power in a conventional rearwards direction. This arrangement has the benefit of providing a much more compact power train with all the major (heavy) components/items located forward of the capsule front wall or bulkhead. This ensures that they will not become upward projectiles threatening to damage the capsule integrity in the event of a mine blast under the vehicle.

Other aspects and preferred forms are disclosed in the specification and/or defined in the appended claims, forming a part of the description of the invention.

Advantages provided by the present invention comprise the following:

Tubular sub-frames allows for
Space efficiency: tubes can be bent around drive line components
Easier to detect fault: all tubes are externally welded and visible
Avoids moisture traps thanks to spacing between tubes and furthermore, the sealed tube construction prevents access by water to internal cavities of the vehicle
Better heat dissipation for drive line components

The bolted joint allows for
Easy connectivity
And modularity: easy creation of different variants

Modular approach to vehicle design allows multiple designs.

Easy connectivity improves the maintainability and manufacturing process.

Increased payload capacity (no gearbox at the rear) especially for utility vehicle designs.

Design of embodiments allows weight saving. For example, tubular chassis, no sub frame below capsule.

Easy access for maintenance.

In protected vehicle applications, enhanced level of blast protection as no heavy components are located below the capsule.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 is front perspective view of a modular vehicle architecture for a protected vehicle having a front module, center module and rear module in the form of a front sub frame, a capsule and, a rear sub frame, respectively, in accordance with one embodiment of the present invention;

FIG. 2 is rear perspective view of the modular vehicle architecture for a protected vehicle of FIG. 1;

FIG. 3 is a perspective view of a partially assembled 6×6 vehicle incorporating a modular vehicle architecture in accordance with an embodiment of the present invention;

FIG. 4 is a front perspective view of a sub-frame and front capsule bulkhead in accordance with a preferred embodiment of the present invention;

FIG. 5 illustrates the attachment between a capsule and sub-frames of a vehicle architecture in accordance with an embodiment of the present invention;

FIG. 6 illustrates a sub-frame connection structure in accordance with a preferred embodiment of the present invention.

### DETAILED DESCRIPTION

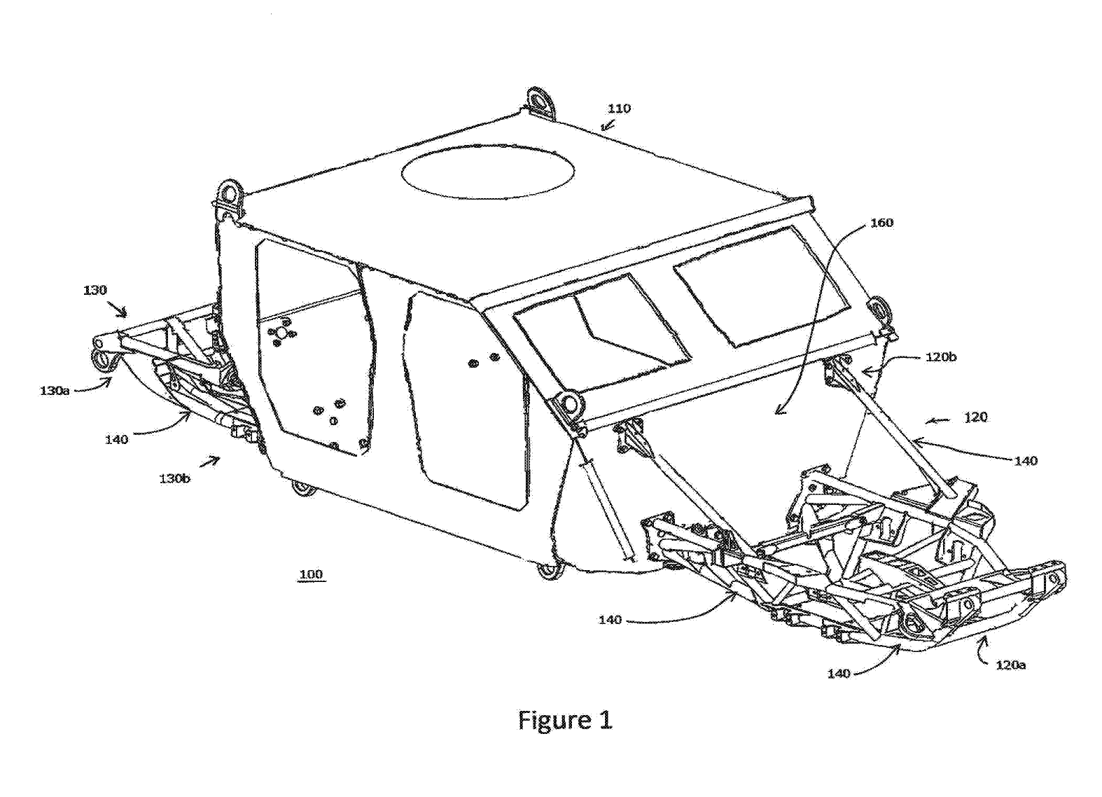

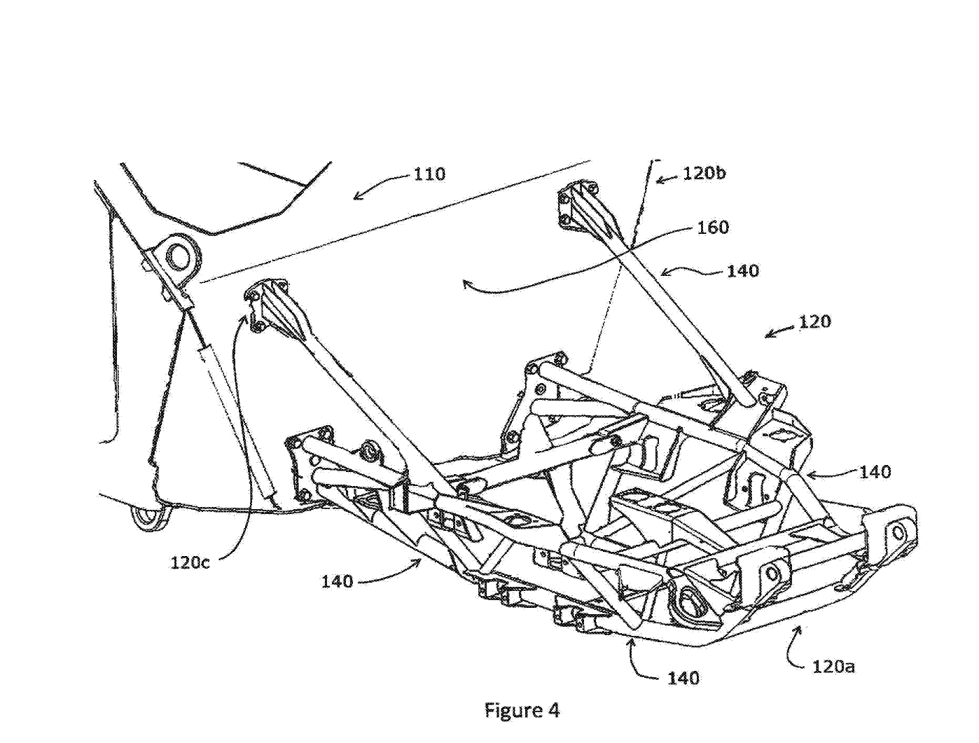

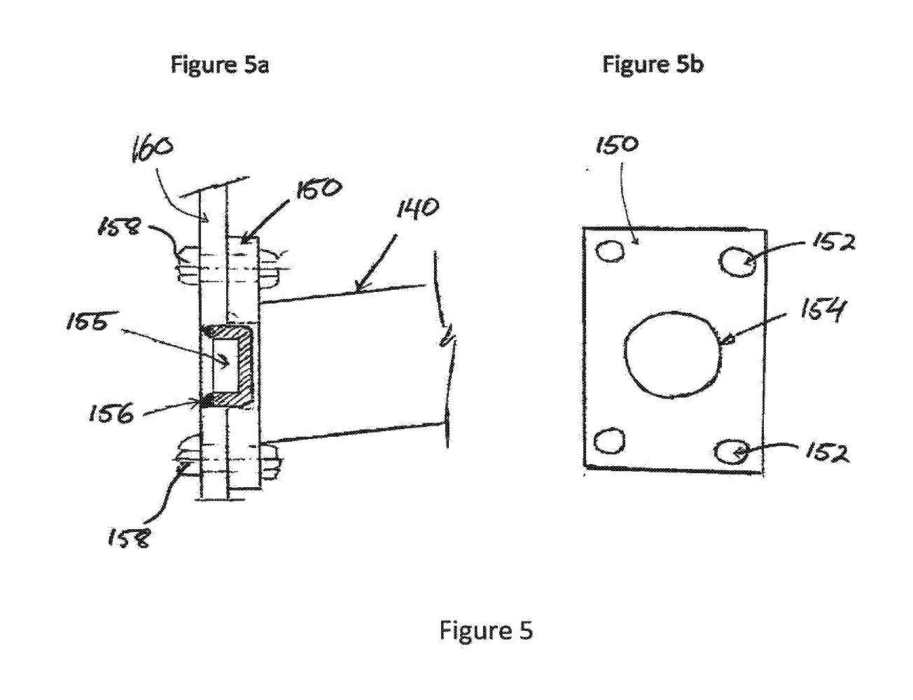

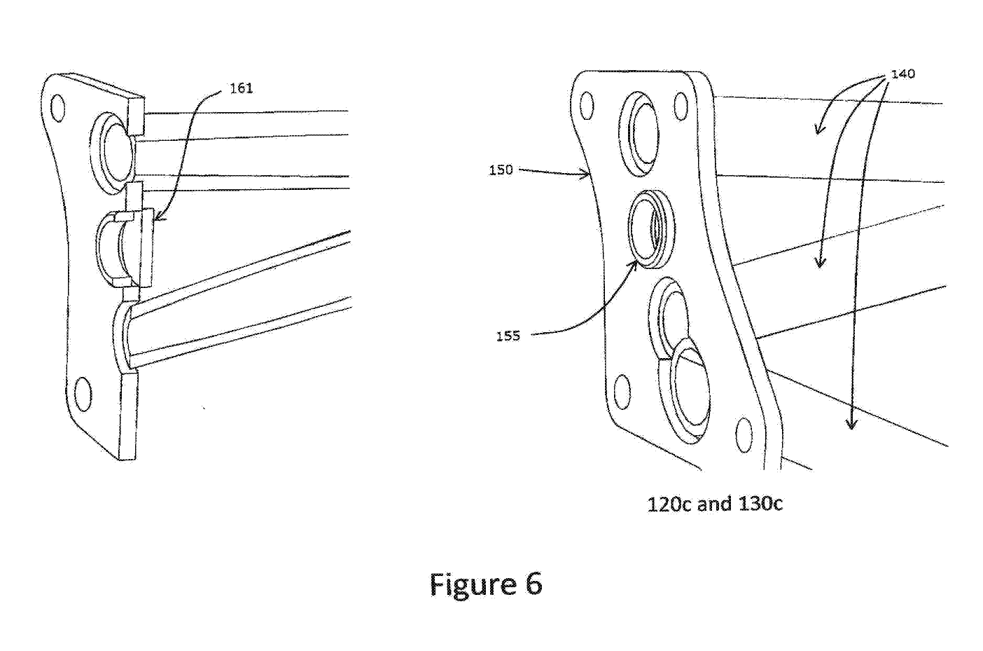

Referring to FIGS. 1 & 2, a protected military vehicle 100 comprising a protected capsule module 110, a front sub-frame module 120 and a rear sub-frame module 130 in accordance with one embodiment of the present invention is shown. The front sub-frame module 120 comprises a distal end 120a and a proximal end 120b, at which are located connections 120c (FIGS. 4 & 6) with the protected capsule module 110. Proximal end 120b of front sub-frame module 120 may be attached to protected capsule module 110 of the vehicle 100 utilising at least one of the connections 120c shown in better detail in FIGS. 5 and 6, significantly increasing the efficiency of assembling vehicle 100. Rear sub-frame module 130 comprises a distal end 130a and a proximal end 130b. Proximal end 130b of rear sub-frame module 130 may be attached to capsule module 110 of the vehicle 100 utilising the connections 130c (FIG. 6) shown in better detail in FIG. 5 or 6 significantly increasing the efficiency of assembling vehicle 100.

In one embodiment, proximal end 120b of front sub-frame module 120 and proximal end 130b of rear sub-frame module 130 are attached to capsule module 110 with connections 120c and 130c, respectively, which in turn comprise detachable mechanical fastening means, for instance, the use of nuts and bolts, dowels, and the like may be used. In this respect, in FIGS. 5 and 6 there are shown attachment structures for connecting sub-frame and capsule modules which are described in greater detail here in below.

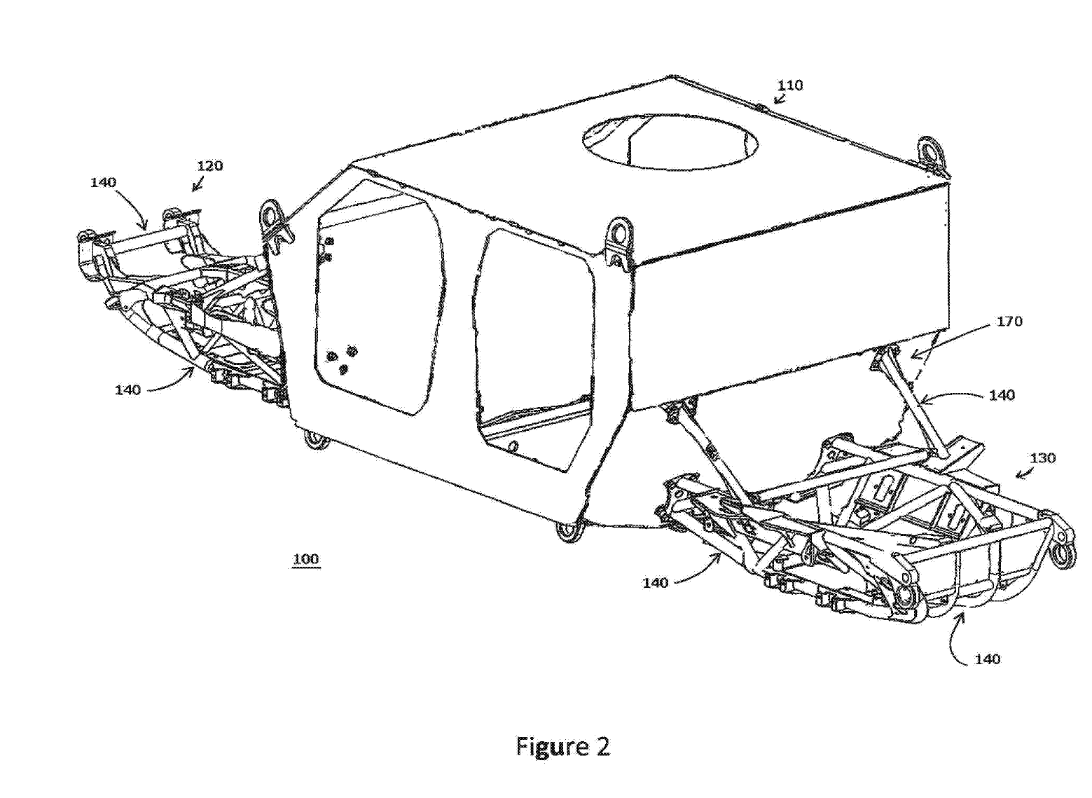

In one embodiment, the rear sub-frame module 130 and front sub-frame module 120 are formed of tubular sub-frame members 140 with a cross section to its structure being a conic section, wherein each of the tubular sub-frame members 140 may comprise steel or any appropriate material as would be understood by the person skilled in the art to provide a relatively lightweight but strong structure, for example aluminium. Preferably, the sub-frame members are comprised of steel given fatigue resistance of steel is superior to aluminium. The center sub-frame module 110 comprises a capsule that forms a cab portion between a front hull wall 160 and a rear hull wall 170 that ultimately provides the crew compartment of the vehicle as shown in FIGS. 1 and 2.

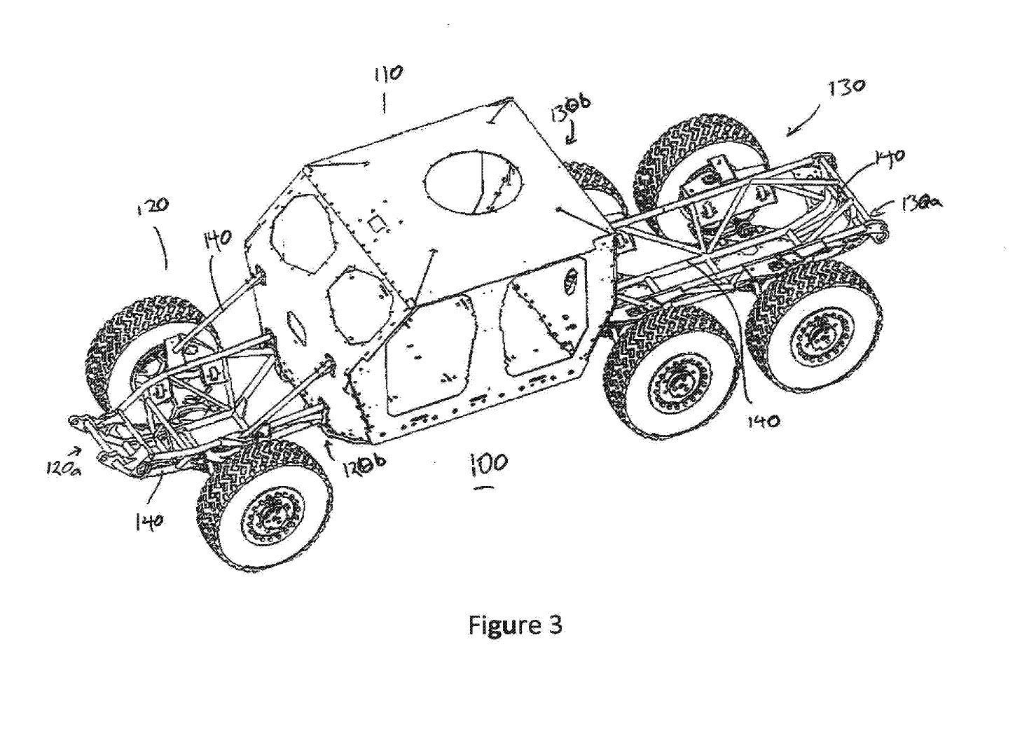

With reference to FIG. 3, for example, the tubular structure of the sub-frames comprises upper and lower main tubular beams joined together via diagonal crisscross tubes with four suspension mounting points welded in place.

Cab portion is designed for protecting occupants or crew. All hulls, for example as indicated at 160 and 170, are designed to defend against ballistic and mine blast threats.

FIG. 4 shows a view of front sub frame 120 and front hull wall 160 of protected capsule module 110.

Front and rear tubular sub-frames 120 and 130 are separated from one another. The capsule 110 sits between the front and rear sub-frames 120 and 130 and allows for different vehicle types with similar design (family of vehicles) to be fabricated. It allows flexibility to build separately or in series the three sections, whereby the three sections can be independently built, packaged and assembled as required. The tubular structure allows ease of access (for maintenance), is lighter in weight, is fully sealed, has strong resistance to bending, and takes less space than for example box section designs.

In fabricating or assembling a vehicle for instance, firstly a capsule is manufactured. Then sub-frames are manufactured, and this can be performed in a separate assembly line. The tubular structure of one or more sub-frames may be built in a jig. Then brackets are welded. Stress is relieved in the built jig. Finally a sand blast is performed and paint is applied to the modular vehicle structure. Sub-frames may be bolted to the capsule before the drive line is fitted. However they could be pre-assembled with drive line components prior to capsule attachment to allow work to be done in parallel thus optimizing the manufacturing process.

Drive line components may comprise major vehicle components, which would comprise the engine, gearbox, transmission etc. In other words, components that are requisite for the vehicle to actually function so that in their absence the vehicle could not function. In contrast auxiliary vehicle components are those that contribute to the functioning of the vehicle but in their absence the vehicle could still function at least to the extent that it would not be immediately impeded from functioning, for example brake pads or windscreen wipers.

With reference to FIGS. 5 and 6, flange plates are welded to a tubular structure and have location dowels welded to them. These dowels allow the easy location into the cabin walls and using bolts to bolt through the flange and the cabin wall hold the sub-frame in place. The bolts are tensioned to hold the dowel firmly in the receiving hole so that the dowels carry a large percentage of the load, for example, during mine blast. The dowel is used to locate the sub frame during assembly. Once located the bolts can be easily assembled and tightened to the required torque. This enables the assembly to be rigidly mounted to the hull and therefore eliminate the fatigue loads that would otherwise be felt by the bolts. During mine blast the dowels work to hold the shearing load that would otherwise be felt by the bolts ensuring the bolts survive a mine blast.

In FIG. 5a an attachment structure for connecting a sub-frame assembly to the cabin is illustrated in cross-section. On the sub-frame assembly side a sub-frame flange plate 150 is shown welded to one or more tubular sub-frame members 140. The face of the flange plate 150 is shown in FIG. 5b, having a central dowel hole 154 around which are positioned a plurality of bolt holes 152 for receiving bolts 158. The surface of flange plate 150 shown in FIG. 5a is, in use, facing and abutting against a portion of the cabin hull wall plate 160 (or 170) as shown in FIG. 5a. The cabin hull wall plate 160 is provided with a generally cylindrical dowel structure 155, which may be welded thereto as shown at 156, that protrudes from the surface of the plate. The dowel 155 is marginally smaller in diameter than the dowel hole 154 in the flange plate so that the flange plate hole 154 fits over the protruding dowel in use when the two are aligned and the flange plate abuts against the hull wall plate. The cabin hull wall plate is also provided with bolt holes corresponding to those, namely bolt holes 152 in the flange plate 150, so that when the flange plate 150 is aligned for attachment to the cabin, bolts 158 may extend through the holes in the flange plate and hull wall for use in securing the two together. It will be appreciated that, although the drawing refers to the cabin front hull wall plate 160, the same means can be used for attachment to the rear hull wall plate 170.

Although in FIG. 5 the attachment structure is shown with the protruding dowel on the hull wall and the receiving dowel hole on the flange plate, it is also possible for this arrangement to be reversed in which case the dowel protrusion is on the flange plate and the dowel hole (or indentation) is formed in the cabin hull wall plate. A sub-frame assembly flange plate constructed in this manner is illustrated in FIG. 6, in cross-section and side perspective views. As shown therein, the dowel protrusion 155 extends from the face of the flange plate 150 to interfit with a corresponding dowel hole in the cabin hull wall plate (not shown in this Figure). In this case the dowel protrusion is open at the front but enclosed at the back with ballistic plate 161. The dowel may be affixed to the flange plate by welding or other convenient means, or may be integrally formed with the flange plate by machining, for example.

Major interfaces to front sub-frame are:
Engine
Gearbox/transfer case/front differentials
Steering
Suspension mounting points: control arms, Spring and damper mounts, Bump stops
Winch
Auxiliary brackets (radiator, bonnet, miscellaneous engine components)
Mudguards
Bull bar/bumper bar/brush bar

Major interfaces to rear sub-frame are:
Fuel tank cradled to rear sub-frame
Rear differentials
Rear steering rack
Suspension mounting points
Towing pintle
Recovery lugs
Tie down lugs
Rear tray
Weapon mount
Spare wheel(s)
“Blue Tank” (tank for aqueous urea, to support European emissions control regulations)

Major interfaces to capsule are:
Weapon mount
Doors
Windscreen
Windows
Side steps
Body panels and protection panels
Roof rack(s) for additional cargo capacity.

In a preferred configuration being able to have, for example, both the engine and gearbox in a side-by-side configuration and residing in the front sub-frame provides the advantageous improvement to payload capacity. In one preferred arrangement, the engine is orientated with flywheel facing forwards and a cross drive unit is provided to transfer power from the engine to the gearbox and transfer case which is mounted next to it in the front frame sub-assembly.

The exemplary protected vehicle architecture shown in FIGS. 1, 2, 3 and 4 may be a light weight military protected vehicle in the range of 7 tons and can be manufactured in three variants, namely Command, Reconnaissance, and Utility vehicle. As a military protected vehicle it may be provided with modular protection in the form of armour kits. The overall design characteristics in this preferred embodiment and as shown in the drawings comprises two sub-frames attached to a protected capsule, a tubular steel chassis assembled with bolt fastenings and dowels. Preferably the gearbox is situated at the front and housed within the front sub-frame. The modular architecture allows multiple designs, easier maintainability and manufacturing processes along with increased payload capacity by virtue of the gearbox situated at the front so there is less weight at the rear. The tubular chassis is light weight and the vehicle affords a high protection level since there is no substantial vehicle element below the occupant capsule.

By virtue of the connection between sub frames and capsule hull as described herein, it will be appreciated that a modular architecture is realised for a protected vehicle. For example, the above noted vehicle variants, will necessitate a number of different hull configurations along with a number of different sub frame configurations that are possible. Accordingly, any given sub frame adapted for connection to the front end of the vehicle capsule may also be adapted for connection to different hull configurations of the capsule and one other sub frame comprising one of a plurality of different sub frame configurations may be adapted for connection to said different hull configurations at the rear of the capsule.

The tubular sub-frames allow for space efficiency given that tubes can be bent around drive line or major vehicle components. It is also easier to detect faults since all tubes are externally welded and visible. Accordingly, the structure avoids moisture traps by virtue of spacing between tubes and there is better heat dissipation for drive line components.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

We claim:

1.-9. (canceled)

10. A modular vehicle architecture, comprising:
a capsule adapted for accommodating at least one occupant;
at least one sub-frame detachably operatively connected to the capsule;
wherein a majority of major functional vehicle components are housed within a sub-frame.

11. A modular vehicle architecture as claimed in claim 10, wherein the major functional vehicle components housed within a sub-frame comprise one or a combination of:
an engine;
a gear box;
a transfer case;
a transmission.

12. A modular vehicle architecture as claimed in claim 10, wherein the sub-frame housing the major functional vehicle components is connected to the front end of the capsule of the vehicle.

13. A modular vehicle architecture as claimed in claim 10, wherein major functional vehicle components housed within the sub-frame are arranged in a side by side configuration.

14. A modular vehicle architecture as claimed in claim 13, wherein the engine is orientated with flywheel facing towards and a cross drive unit is arranged to transfer power to the beside mounted gearbox and transfer case.

15. A modular vehicle architecture as claimed in claim 10, wherein the sub-frame construction comprises members of tubular structure having a cross section corresponding to a conic section.

16. A modular vehicle architecture as claimed in claim 15, wherein the sub-frame members have a cross section corresponding to one of:
a circle;
an ellipse.

17. A vehicle comprising a modular vehicle architecture as claimed in claim 10, wherein the vehicle comprises:
a centre module for protecting vehicle occupants comprising a capsule adapted for accommodating at least one occupant;
a front sub-frame detachably operatively connected to the front end of the capsule;
a rear sub-frame detachably operatively connected to the rear of the capsule comprising members of tubular structure having a cross section corresponding to a conic section and adapted for accommodating a payload;
wherein the vehicle is adapted for use as one or more of:
a protected military vehicle;
a civilian passenger vehicle;
a mining vehicle;
a fire fighting vehicle;
a police vehicle;
an emergency services vehicle;
an agricultural vehicle.

18. A method of assembling a vehicle comprising, the steps of:
providing a centre module comprising a capsule adapted for accommodating at least one occupant;
providing a first sub-frame comprising sub-frame members of tubular structure having a cross section corresponding to a conic section;
providing a second sub-frame comprising sub-frame members of tubular structure having a cross section corresponding to a conic section;
detachably connecting the first sub-frame to the front of the centre module;
detachably connecting the second sub-frame to the rear of the centre module.

19. A method of assembling a vehicle as claimed in claim 18, further comprising the steps of:
installing major functional vehicle components into the vehicle such that a majority of the major functional vehicle components are housed within the first sub-frame.

20. A method of assembling a vehicle as claimed in claim 19, wherein the step of installing major functional vehicle components within the first sub-frame comprises arranging the major functional vehicle components in the first sub-frame in a side by side configuration.

21. A method of assembling a vehicle as claimed in claim 19, wherein the major functional vehicle components housed within the first sub-frame comprise one or a combination of:
an engine;
a gear box;
a transfer case;
a transmission.

22. A modular vehicle architecture having:
a capsule adapted for accommodating at least one occupant;
at least one sub-frame detachably connectable to the capsule and constructed from members of tubular structure having a circular or elliptical cross-sectional profile;
wherein one or more connections between the capsule and the at least one sub-frame comprises a fastening between a hull plate of the capsule and a sub-frame flange of the sub-frame, and wherein the fastening comprises a combination of a bolt and a dowel where the dowel is for locating the sub frame assembly during its assembly and the bolt is arranged for tightening upon locating the sub frame assembly such that fatigue loads on the connection are minimised and the dowel is capable of dissipating shearing loads.

23. A modular vehicle architecture as claimed in claim 22, wherein the fastening includes a dowel and a plurality of bolts arranged therearound.

24. (canceled)

25. (canceled)

26. A modular vehicle architecture as claimed in claim 15, wherein the sub-frame members are externally welded and highly visible for maintenance.

27. A modular vehicle architecture as claimed in claim 15, wherein the sub-frame members are spaced to avoid moisture traps and liquid pooling within the chassis of the vehicle.

28. A modular vehicle architecture as claimed in claim 15, wherein the sub-frame members are configured to house major functional vehicle components within a sub-frame.

29. A modular vehicle architecture as claimed in claim 15, wherein the sub-frame members are configured to allow heat dissipation from major functional vehicle components and auxiliary vehicle components housed within the sub-frame.

30. A modular vehicle architecture as claimed in claim 15, wherein one or more connections between the capsule and the at least one sub-frame comprises a fastening between a hull plate of the capsule and a sub-frame flange of the sub-frame.

31. A modular vehicle architecture as claimed in claim 30, wherein the fastening comprises one or a combination of a bolt and a dowel where the dowel is for locating the sub frame assembly during its assembly and the bolt is arranged for tightening upon locating the sub frame assembly such that fatigue loads on the connection are minimised and the dowel is capable of dissipating shearing loads.
